(19) United States
(12) Patent Application Publication
(10) Pub. No.: US 2008/0170417 A1
(43) Pub. Date: Jul. 17, 2008

(54) ADJUSTABLE SHUNT REGULATOR WITH SOFT-START REFERENCE

(76) Inventor: Jian YANG, Thousand Oaks, CA (US)

Correspondence Address: O'Melveny & Myers LLP;IP&T Calendar Department LA-1118, 400 South Hope Street, Los Angeles, CA, 90071-2899, US

(21) Appl. No.: 11/622,960

(22) Filed: Jan. 12, 2007

(51) Int. Cl. H02M 3/00; G05F 1/613; G05F 1/44

(52) U.S. Cl. 363/15; 323/238; 323/223

(57) ABSTRACT

An adjustable shunt regulator comprises an operational amplifier, a transistor having a base terminal operatively connected to the output of the operational amplifier, a diode operatively connected in parallel with the transistor, and a voltage reference connected to the inverting input of the operational amplifier. The operational amplifier provides an output signal at the output thereof that corresponds to a difference between an input signal applied to the non-inverting input and the voltage reference. The output signal controls a voltage between the collector and emitter. A current source is operatively connected to the inverting input of the operational amplifier, and a capacitor is operatively connected to the inverting input of the operational amplifier in parallel with voltage reference. Upon a start-up condition of the shunt regulator, the capacitor is charged by current supplied by the current source causing the voltage reference to be limited to a charge voltage of the capacitor. The charge time of the capacitor defines a delay period before the voltage reference reaches a final voltage. Charging of the capacitor stops when the capacitor voltage equals the final voltage of the voltage reference. As a result, the operational amplifier is prevented from going into a saturation state, thereby minimizing overshoot of an output voltage regulated by the shunt regulator.

### BACKGROUND OF THE INVENTION

1. Field of the Invention

The present invention relates to voltage regulators, and more particularly, to an adjustable shunt regulator having a soft-start reference that reduces regulated voltage overshoot during start-up.

2. Description of Related Art

Adjustable shunt regulators are widely used in isolated power converter applications to provide a voltage that varies in correspondence with a reference signal. FIG. 1 schematically illustrates a typical shunt regulator 18 as including a precision voltage reference 10, an operational amplifier (i.e., op amp) 12, a bipolar transistor 14, and a diode 16. The output voltage of the shunt regulator is defined across the transistor 14 (i.e., between OUT and GND). The precision voltage reference 10 is connected between the inverting input of the op amp 12 and ground. A reference input signal (“Ref”) is applied to the non-inverting input of the op amp 12. The output of the op amp 12 corresponds to the difference between the reference input and the reference voltage, and this output drives the base terminal of the transistor 14 to control the voltage between the collector and emitter terminals of the transistor. The collector terminal of the transistor 14 is connected to the voltage output pin (i.e., OUT), and the emitter terminal of the transistor is connected to ground (i.e., GND). The diode 16 is connected in parallel with the transistor 14 between the collector and emitter.

Shunt regulators may be included in an output stage of an isolated power converter to provide a feedback signal corresponding to the output voltage of the power converter. By way of example, FIG. 2 shows a portion of an output stage of a power converter 28 in which a conventional shunt regulator 18 is used. The power converter 28 provides an output voltage Vₒ. For simplification, FIG. 2 omits known aspects of the power converter, such as a primary and secondary power stage that rectifies an alternating voltage to provide output voltage Vₒ. The shunt regulator 18 is coupled to the output voltage Vₒ through a current-limiting resistor 32. Resistors 20 and 22 are connected in series between the output voltage Vₒ terminal and ground to provide a voltage divider that produces a voltage proportional to the output voltage Vₒ. This proportional voltage is applied to the input terminal of the shunt regulator 18. The shunt regulator 18 will vary the voltage across the internal transistor in correspondence with the output voltage Vₒ of the power converter, which in turn controls the current drawn through the resistor 32. A loop compensation network 26 may be connected between the OUT pin of the shunt regulator and the junction between resistors 20 and 22. The loop compensation network 26 stabilizes and avoid oscillations in the output stage of the power converter.

Opto-isolator 24 is coupled in series with the resistor 32 to derive a feedback signal corresponding to the current through the resistor 32. Specifically, the opto-isolator 24 includes a photo-diode that produces light having an amplitude proportional to the output current, and a photo-transistor that produces an electrical signal in proportion to the light output of the photo-diode. The resulting electrical signal is provided to a pulse-width modulation (PWM) controller 30 of the power converter. The PWM controller 30 generates a duty cycle of voltage waveform that is rectified to produce the output voltage Vₒ. This way, if the output voltage Vₒ of the power converter gets too high, the shunt regulator 18 increases the feedback signal to cause the PWM controller 30 to reduce the duty cycle. Conversely, if the output voltage Vₒ of the power converter gets too low, the shunt regulator 18 decreases the feedback signal to cause the PWM controller 30 to increase the duty cycle. Hence, the feedback signal is used to regulate the output voltage Vₒ of the power converter. This application of a shunt regulator is often referred to as an “error amplifier,” since it produces an error signal that reflects the deviation of the output voltage Vₒ from its desired value.

This arrangement of a shunt regulator is commonly used in isolated power supply applications because of its simplicity and low cost of use. Despite these advantages, however, conventional shunt regulators also have drawbacks. One of the drawbacks is that the error amplifier control loop is open at start-up, causing the output voltage Vₒ of the power converter to overshoot the desired level. This is because the shunt regulator receives an input signal proportional to the output voltage Vₒ that is essentially zero at the moment immediately following start-up. Since the precision voltage reference in the shunt regulator rapidly jumps to its final voltage following start-up, the difference between the reference voltage and the input signal to the shunt regulator is extremely large. This causes the op amp to saturate because the differential input voltage is too high for the op amp's gain, which drives the output level of the op amp to its peak level. In turn, this causes the PWM controller to maximize the duty cycle in order to increase the output voltage Vₒ. As a result, the output voltage Vₒ of the power converter reaches the desired regulated voltage very quickly. Before the control loop is able to react, the saturated op amp will continue driving at its peak level of output, which causes the output voltage Vₒ to overshoot beyond the regulated voltage. The magnitude of the overshoot depends on how long it takes for the control loop to react.

FIG. 3 is a graph showing an exemplary output voltage waveform in which the output voltage Vₒ overshoot occurs using traditional shunt regulators. The x-axis reflects time and the y-axis reflects output voltage Vₒ. As shown on the graph, the output voltage Vₒ ramps up very quickly and passes the threshold before settling at the threshold value. The overshoot refers to the amount that the output voltage exceeds the threshold.

The overshoot voltage is undesirable because electronic devices powered by the power converter (e.g., microprocessors) are often designed to accept voltages within a very limited tolerance range (referred to as the “on” threshold). If the output voltage Vₒ exceeds this narrow tolerance range, the electronic devices can be damaged. Currently, there are a few known methods for reducing the overshoot. One method is to increase the rate at which the output voltage rises, which reduces the error between the output voltage and the voltage reference during start-up. FIG. 4 provides an example of an alternative circuit 38 used to control voltage rate increases.

FIG. 4 is very similar to FIG. 2, except it contains additional circuitry used to reduce overshoot of the output voltage on start-up. The alternative circuit retards the output voltage Vₒ measurement provided as an input to the error amplifier so that the op amp does not immediately go into saturation. This alternative circuit 38 includes the following additional components (which are emphasized inside the dotted box): resistors 42 and 44, capacitor 48, PNP transistor 46, and diode 40. Resistor 44 is coupled to the reference input of the shunt regulator 18 through transistor 46, such that the resistor is coupled in parallel with the resistor 20 of the voltage divider. Accordingly, at start-up, the input signal provided to the shunt regulator 18 by the voltage divider is shifted toward Vₒ to reflect a measured voltage that is a higher in proportion to Vₒ. Resistor 42 and capacitor 48 are connected in series with the capacitor 48 coupled to the base terminal of the transistor 46. The capacitor 48 begins to charge upon start-up to slowly decrease the flow of current through the transistor 46. Eventually, the transistor 46 will turn off, and the voltage divider will operate normally. Hence, the error signal corresponding to the difference between voltage of the reference input signal and the precision voltage reference is retarded for a time period until the capacitor 48 becomes fully charged. When the power converter is turned off, the capacitor 48 is discharged through the diode 40 to prepare the circuit for future use.

While mitigating the problem somewhat, this circuit arrangement is still open loop at start-up, so there will be an initial period in which the op amp goes into saturation, which enables the overshoot condition to occur. Hence, the output voltage Vₒ still does not ramp up very smoothly. There is also an additional disadvantage of having to include many additional circuit components that increase the cost and complexity of the power converter circuit.

Accordingly, it would be desirable to provide an improved and more efficient way of controlling the rate at which the output voltage of the shunt regulator increases during start-up so as to avoid overshoot.

### SUMMARY OF THE INVENTION

The present invention overcomes these drawbacks by providing an adjustable shunt regulator that causes the reference voltage to ramp up gradually as opposed to reaching its final value immediately. The present invention is able to accomplish this with fewer components and a smoother ramp up than conventional methods.

In an embodiment of the invention, an adjustable shunt regulator comprises an operational amplifier, a transistor having a base terminal operatively connected to the output of the operational amplifier, a diode operatively connected in parallel with the transistor, and a voltage reference connected to the inverting input of the operational amplifier. The operational amplifier provides an output signal at the output thereof that corresponds to a difference between an input signal applied to the non-inverting input and the voltage reference. The output signal controls a voltage between the collector and emitter. A current source is operatively connected to the inverting input of the operational amplifier, and a capacitor is operatively connected to the inverting input of the operational amplifier in parallel with voltage reference. Upon a start-up condition of the shunt regulator, the capacitor is charged by current supplied by the current source causing the voltage reference to be limited to a charge voltage of the capacitor. The charge time of the capacitor defines a delay period before the voltage reference reaches a final voltage. Charging of the capacitor stops when the capacitor voltage equals the final voltage of the voltage reference. As a result, the operational amplifier is prevented from going into a saturation state. A switch may be operatively connected to the capacitor to discharge the capacitor to ground to prepare the circuit for the start-up condition.

In another embodiment of the invention, an isolated power converter comprises a primary side power stage, a transformer, a secondary side power stage, and a feedback circuit that includes an adjustable shunt regulator. The primary side power stage provides an alternating voltage signal and a pulse width modulator adapted to control a duty cycle of the alternating voltage signal responsive to a feedback signal. The transformer has a primary winding and a secondary winding, with the primary side power stage operatively coupled to the primary winding to apply the alternating voltage signal thereto, and the secondary side power stage operatively coupled to the secondary winding to receive the alternating voltage signal inductively coupled through the transformer. The secondary side power stage comprises a rectifier adapted to rectify the alternating voltage signal to a direct current output voltage. The shunt regulator is adapted to receive an input signal proportional to the output voltage and provide the feedback signal corresponding to a difference between the input signal and a reference voltage. The feedback signal is operatively coupled to the pulse width modulator.

More particularly, the shunt regulator is adapted to retard the rise time of the reference voltage during a start-up condition of the power converter so as to minimize an overshoot of the output voltage beyond a desired level. The shunt regulator further comprises an operational amplifier, a transistor having a base terminal operatively connected to the output of said operational amplifier, a diode operatively connected in parallel with the transistor, a current source operatively connected to the inverting input of the operational amplifier, and a capacitor operatively connected to the inverting input of the operational amplifier. The operational amplifier provides an output signal at the output thereof that corresponds to a difference between the input signal applied to the non-inverting input and the reference voltage. The output signal thereby controls conductance of the transistor between the collector and emitter in order to provide the feedback signal. Upon a start-up condition of the power converter, the capacitor is charged by current supplied by the current source causing the reference voltage to be limited to a charge voltage of the capacitor. A switch is operatively connected to the capacitor to discharge the capacitor prior to commencing the start-up condition. Charge time of the capacitor defines the rise time of the reference voltage before reaching a final voltage level such that charging of the capacitor stops when the capacitor voltage equals the final voltage level.

In yet another embodiment of the invention, a method for regulating an output voltage comprises generating an output voltage, deriving a sample voltage proportional to the output voltage, comparing the sample voltage to a reference voltage to derive an error signal, and regulating the performance of the generating step responsive to the error signal. During a start-up condition, the method further includes retarding the rise time of the reference voltage so as to minimize overshoot of the output voltage above a desired level. The retarding step comprises charging a capacitor so that the reference voltage substantially follows the capacitor voltage. The method further includes discharging the capacitor prior to initiating the start-up condition.

A more complete understanding of the adjustable shunt regulator will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a block diagram of a conventional shunt regulator.

FIG. 2 is a block diagram of a conventional shunt regulator being used in a power converter circuit.

FIG. 3 is a graph showing the overshoot voltage that occurs when using conventional shunt regulators.

FIG. 4 is a partial circuit diagram of an alternative circuit used to reduce overshoot when using a conventional shunt regulator.

FIG. 5 is a block diagram of an adjustable shunt regulator with soft-start reference in accordance with an embodiment of the invention.

FIG. 6 is a block diagram of a power converter circuit using the adjustable shunt regulator in accordance with an embodiment of the invention

FIG. 7 is a graph showing the elimination of the overshoot voltage when using the adjustable shunt regulator in accordance with an embodiment of the invention.

### DETAILED DESCRIPTION OF THE PREFERRED EMBODIMENT

The present invention satisfies the need for an adjustable shunt regulator that ramps up the output voltage in a more gradual manner in order to control overshoot of the output voltage. The present invention is able to accomplish this with less components and in a more efficient manner than the conventional methods.

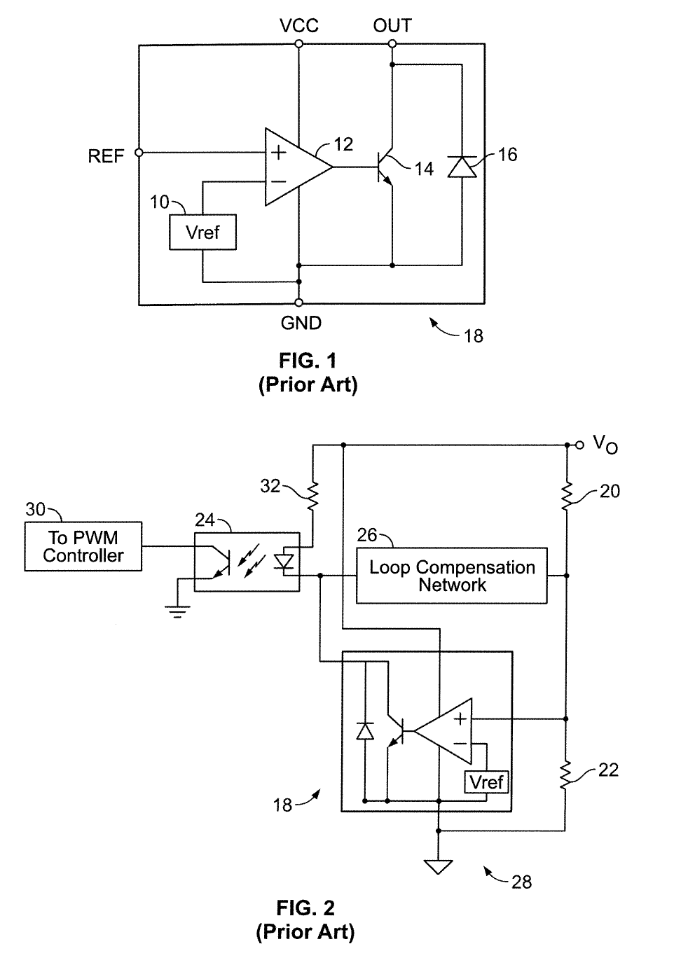

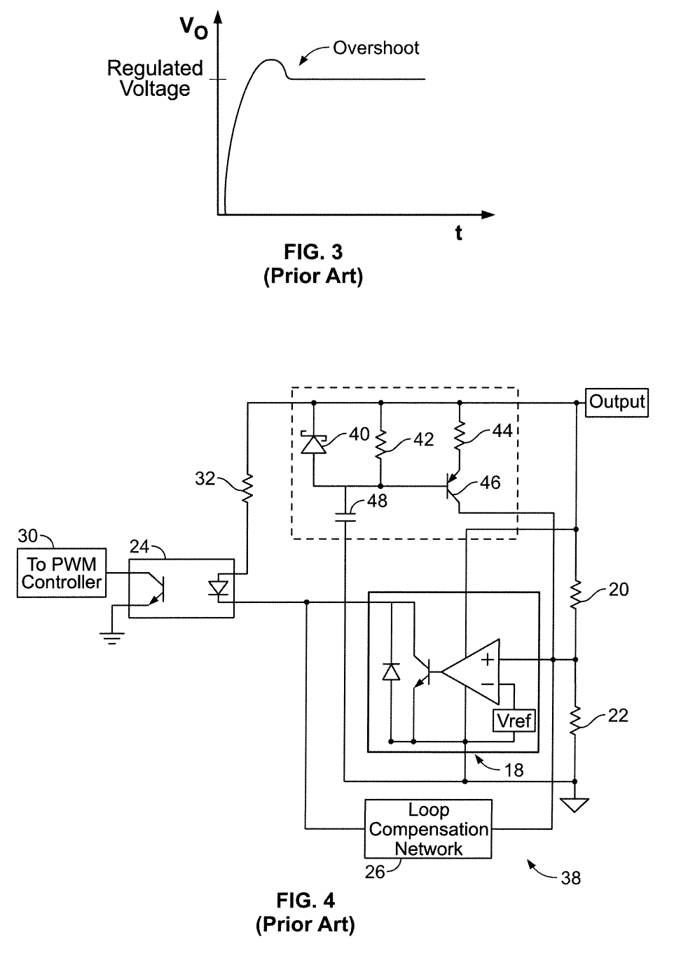

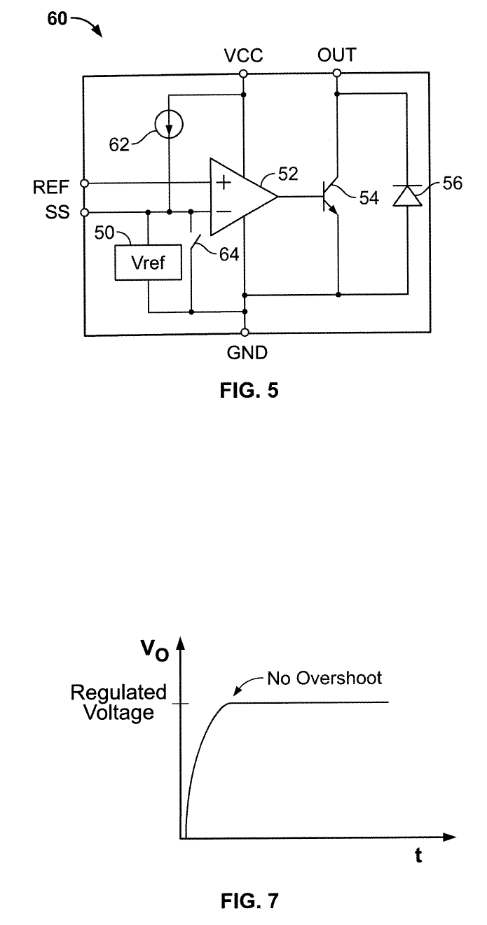

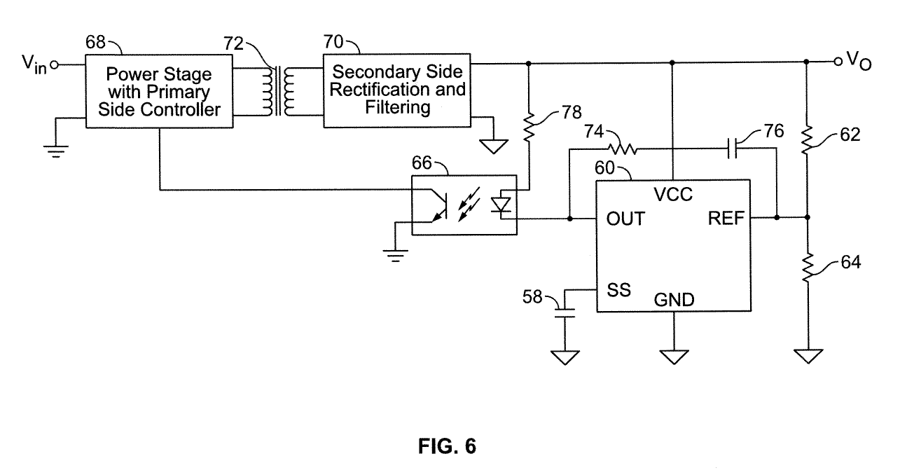

Referring now to FIG. 5, an adjustable shunt regulator is schematically illustrated in accordance with an embodiment of the invention. The adjustable shunt regulator of FIG. 5 is similar to the conventional shunt regulator of FIG. 1, except that it further includes an internal current source 62 connected between Vcc and the non-inverting input of the op amp 52 and a switch 64 connected between the non-inverting input of the op amp 52 and ground. In an embodiment of the invention, the adjustable shunt regulator may be contained in a semiconductor package having plural external pins (e.g., VCC, OUT, REF, SS, GND) enabling connections to the internal components. An external capacitor 58 also connects to the inverting input of the op amp 52 through a soft-start pin (“SS”), as will be further described below with respect to FIG. 6.

As in the preceding description, the adjustable shunt regulator 60 of FIG. 5 includes a precision voltage reference 50, an op amp 52, a bipolar transistor 54, and a diode 56. The output voltage of the shunt regulator is defined across the transistor 54 (i.e., between OUT and GND). The precision voltage reference 50 is connected between the inverting input of the op amp 52 and ground. A reference input signal (“Ref”) is applied to the non-inverting input of the op amp 52. The output of the op amp 52 corresponds to the difference between the reference input and the reference voltage, and this output drives the base terminal of the transistor 54 to control the voltage between the collector and emitter terminals of the transistor. The collector terminal of the transistor 54 is connected to the voltage output pin (i.e., OUT), and the emitter terminal of the transistor is connected to ground (i.e., GND). The diode 56 is connected in parallel with the transistor 54 between the collector and emitter.

FIG. 6 shows a power converter including the adjustable shunt regulator 60 in accordance with an embodiment of the present invention. The power converter includes a primary side power stage 68, a transformer 72, and a secondary side rectification and filtering stage 70. As known in the art, the primary power stage 68 provides an alternating voltage waveform that is applied to the transformer 72. The secondary side power stage 70 receives the alternating voltage waveform inductively coupled through the transformer, and rectifies and filters the waveform to produce a direct current output voltage Vₒ. The shunt regulator 60 provides a feedback signal to the primary side power stage 68 through an opto-isolator 66. The primary power stage 68 uses the feedback signal to adjust the duty cycle of the alternating voltage waveform in order to maintain the output voltage Vₒ at a substantially constant level.

As discussed above, the resistors 62 and 64 are connected in series between the output voltage terminal and ground, providing a voltage divider that applies a feedback signal to the input terminal of the adjustable shunt regulator 60 that is proportional to the output voltage Vₒ. Opto-isolator 66 is coupled in series with the output resistor to derive an output current feedback signal used to regulate performance of the power converter. Specifically, the opto-isolator 66 includes a photo diode that produces light having an amplitude proportional to the output current, and the photo-transistor produces an electrical signal in proportion to the light output of the photo-diode. An RC circuit is formed by resistor 74 and capacitor 76 and is connected between the OUT pin of the adjustable shunt regulator 60 and the junction between resistors 62 and 64. The RC circuit provides loop compensation by stabilizing and avoid oscillations in the circuit.

Referring now to both FIGS. 5 and 6, the internal current source 62 turns on upon start-up by drawing power from Vcc. After being turned on, the internal current source 62 begins charging the external capacitor 58. Since the external capacitor 58 is coupled in parallel with the precision voltage reference 50, the voltage across the capacitor 58 controls the precision voltage reference 50 so that it does not immediately jump to its final value. Instead, the precision voltage reference 50 follows the voltage of the external capacitor 58 and reaches its final value more gradually at a time period defined by the charging rate of the external capacitor 58. As a result, the initial error between the voltage reference 50 and the proportional measurement of the output voltage Vₒ is held to a reduced value during the start-up phase, thereby preventing the op amp 52 from going into a saturation condition. The op amp 52 is then better able to control its output so that the output voltage Vₒ increases at a more controlled rate and does not overshoot the desired regulated voltage. The internal current source 62 stops supplying current when the external capacitor 58 reaches its maximum voltage. After the start-up phase has ended, the adjustable shunt regulator 60 operates like a conventional shunt regulator that was described in detail above. When power to the device is turned off, the internal switch 64 is closed to discharge the external capacitor 58 so that it is ready for the next time the device is turned on.

FIG. 7 is a graph showing the output voltage Vₒ waveform during start-up in accordance with the present invention. The x-axis represents time and the y-axis represents output voltage Vₒ. As is shown in the graph, the output voltage Vₒ gradually ramps up to the regulated voltage value with no overshoot.

As compared to the conventional circuit of FIG. 4, the present invention has some key advantages. First, the present invention allows the circuit to remain in a closed loop condition during start-up, which is important because the circuit is able to react to changes in the output voltage Vₒ. The feature is not present in the conventional circuit shown in FIG. 4, which effectively prevents operation of the voltage divider during start-up so that the error amplifier is not accurately detecting output voltage Vₒ. Because it is open-loop, there is no feedback of the output voltage Vₒ until the output voltage reaches the desired regulated voltage level. The present invention also provides a smoother and more gradual ramp up to the regulated voltage, so it is better able control the output voltage Vₒ from overshooting.

Having thus described a preferred embodiment of an adjustable shunt regulator with soft-start reference, it should be apparent to those skilled in the art that certain advantages of the described method and apparatus have been achieved. It should also be appreciated that various modifications, adaptations, and alternative embodiments thereof may be made within the scope and spirit of the present invention. The invention is defined solely by the following claims.

What is claimed is:

1. An adjustable shunt regulator, comprising:
an operational amplifier having an inverting input, a non-inverting input, and an output;
a transistor having a base, collector and emitter, the base of the transistor operatively connected to the output of said operational amplifier;
a diode operatively connected in parallel with said transistor;
a current source operatively connected to the inverting input of said operational amplifier;
a capacitor operatively connected to said inverting input of said operational amplifier; and
a voltage reference connected to the inverting input of said operational amplifier, the operational amplifier providing an output signal at the output thereof that corresponds to a difference between an input signal applied to the non-inverting input and the voltage reference, the output signal thereby controlling a voltage between the collector and emitter;
wherein, upon a start-up condition of the shunt regulator, the capacitor is charged by current supplied by the current source causing the voltage reference to be limited to a charge voltage of the capacitor, whereby the operational amplifier is prevented from going into a saturation state.

2. The adjustable shunt regulator of claim 1, further comprising a switch operatively connected to the capacitor, the switch being adapted to discharge the capacitor.

3. The adjustable shunt regulator of claim 1, wherein the operational amplifier, the transistor, the internal current source, and the diode are contained within a common package, and the capacitor is externally coupled to the package.

4. The adjustable shunt regulator of claim 1, wherein charge time of the capacitor defines a delay period before the voltage reference reaches a final voltage.

5. The adjustable shunt regulator of claim 4, wherein charging of the capacitor stops when the capacitor voltage equals the final voltage of the voltage reference.

6. An isolated power converter comprising:
a primary side power stage providing an alternating voltage signal and a pulse width modulator adapted to control a duty cycle of the alternating voltage signal responsive to a feedback signal;
a transformer having a primary winding and a secondary winding, the primary side power stage operatively coupled to the primary winding to apply the alternating voltage signal thereto;
a secondary side power stage operatively coupled to the secondary winding to receive the alternating voltage signal inductively coupled through the transformer, the secondary side power stage comprising a rectifier adapted to rectify the alternating voltage signal to a direct current output voltage;
a shunt regulator adapted to receive an input signal proportional to the output voltage and provide the feedback signal corresponding to a difference between the input signal and a reference voltage, the feedback signal being operatively coupled to the pulse width modulator, the shunt regulator being further adapted to retard the rise time of the reference voltage during a start-up condition of the power converter so as to minimize an overshoot of the output voltage beyond a desired level.

7. The isolated power converter of claim 6, further comprising an opto-isolator operatively coupled between the shunt regulator and the pulse width modulator.

8. The isolated power converter of claim 6, wherein the shunt regulator further comprises:
an operational amplifier having an inverting input, a non-inverting input, and an output;
a transistor having a base, collector and emitter, the base of the transistor operatively connected to the output of said operational amplifier;
a diode operatively connected in parallel with said transistor;
a current source operatively connected to the inverting input of said operational amplifier; and
a capacitor operatively connected to said inverting input of said operational amplifier;
wherein the operational amplifier provides an output signal at the output thereof that corresponds to a difference between the input signal applied to the non-inverting input and the reference voltage, the output signal thereby controlling conductance of the transistor between the collector and emitter, the transistor thereby providing the feedback signal;
wherein, upon a start-up condition of the shunt regulator, the capacitor is charged by current supplied by the current source causing the reference voltage to be limited to a charge voltage of the capacitor.

9. The isolated power converter of claim 8, further comprising a switch operatively connected to the capacitor, the switch being adapted to discharge the capacitor.

10. The isolated power converter of claim 8, wherein the operational amplifier, the transistor, the internal current source, and the diode are contained within a common package, and the capacitor is externally coupled to the package.

11. The isolated power converter of claim 8, wherein charge time of the capacitor defines the rise time of the reference voltage before reaching a final voltage level.

12. The isolated power converter of claim 11, wherein charging of the capacitor stops when the capacitor voltage equals the final voltage level.

13. A method for regulating an output voltage, comprising:
generating an output voltage;
deriving a sample voltage proportional to the output voltage;
comparing the sample voltage to a reference voltage to derive an error signal;
regulating the performance of the generating step responsive to the error signal; and
during a start-up condition, retarding the rise time of the reference voltage so as to minimize overshoot of the output voltage above a desired level.

14. The method of claim 13, wherein the retarding step comprises charging a capacitor so that the reference voltage substantially follows the capacitor voltage.

15. The method of claim 14, further comprising discharging the capacitor prior to initiating the start-up condition.

16. The method of claim 13, further comprising communicating the error signal through an isolated communication link.

17. The method of claim 13, wherein the generating step further comprises rectifying an alternating voltage signal.

18. The method of claim 17, wherein the regulating step further comprises adjusting a duty cycle of the alternating voltage signal responsive to the error signal.
